(19) United States
(12) Patent Application Publication
(10) Pub. No.: US 2015/0198755 A1
(43) Pub. Date: Jul. 16, 2015

(54) Lighting Control for Ambient Light Powered Reticules

(71) Applicant: Chris M. Roenker, Brockport, MA (US)

(72) Inventor: Chris M. Roenker, Brockport, MA (US)

(21) Appl. No.: 14/154,510

(22) Filed: Jan. 14, 2014

(51) Int. Cl. F21V 8/00; G02B 23/16; F21V 21/00; H05B 33/08; F21K 99/00

(52) U.S. Cl. CPC G02B 6/0005; H05B 33/0845; F21K 9/52; F21V 21/00; G02B 23/16

(57) ABSTRACT

The present invention is a lighting control unit for scopes and other devices that utilize ambient light for one of their components. In its most basic form the control unit will have a means by which it can be mounted in a usable configuration with the device and a simple user controlled circuit powering an LED or other light source. A wave-guide is utilized to channel light from the source to whatever collective apparatus is used on the device.

### FIELD OF THE INVENTION

The present invention relates to the field of optics and more particularly relates to a lighting control unit for adjusting the brightness of reticules, such as for a reflector scope, which utilize ambient light for illumination.

### BACKGROUND OF THE INVENTION

The use of reticules is well known in the art. The reflector sight was invented in the early part of the century. Reflector sights utilize either lenses or mirrors to project the image of a reticule into a users field of view. Often, ambient light or an internal light source, such as tritium, or both, power these reticules. Reticules powered by ambient light are by their nature at the mercy of the user's environment. If a cloud passes overhead the level of ambient light will drop, and the reticule will grow dimmer. Sometimes this can be an advantage. Other times it may distract a user. These scopes usually collect ambient light through the use of a large wave-guide collector that collects the ambient light and channels it for use to illuminate the reticule.

What is needed, then, is a means by which a minimum level of illumination may be provided to a wave-guide collector so that the reticule will never dim beyond a minimum threshold. No such product exists on the market today. The present invention is a lighting control unit that generates a minimum threshold of light and directs that light toward the wave-guide collector of the scope or other device. The present invention represents a departure from the prior art in that the lighting control unit of the present invention allows for user controlled ambient light to be utilized by a scope or other similar device in an effort to normalize reticule illumination. The solution should be readily adaptable or constructed for various scopes and other devices on the current market and should also be readily adapted to become an integral part of its host devices.

### SUMMARY OF THE INVENTION

In view of the foregoing disadvantages inherent in the known types of scopes and other devices that use ambient light driven illumination techniques, this invention provides a means of maintaining a minimum lighting threshold for such devices. As such, the present invention's general purpose is to provide a new and improved lighting control unit that is user operable to provide a user determined minimum ambient light threshold.

To accomplish these objectives, the lighting control unit comprises a controlled light source and a wave-guide that directs light from the source to a wave-guide collector of the scope or other device. For convenience, the lighting control ideally mounts upon the scope or other device and the wave-guide may be directed to a wave-guide collector at any location on the scope or other device. A means of control allows the user to activate and control the light output of the lighting control unit.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a scope with an exemplary lighting control unit according to the teachings of this invention attached.

FIG. 2 is a close up view of the scope and lighting control unit interface, taken in circle A of FIG. 1.

FIG. 3 is another perspective view of the scope and lighting control unit of FIG. 1.

FIG. 4 is a top plan view of the scope and lighting control unit of FIG. 1.

FIG. 5 is an exploded view of the scope and lighting control unit of FIG.

FIG. 6 is a top perspective view of the lighting control unit of FIG. 1.

FIG. 7 is a bottom perspective view of the lighting control unit of FIG. 1.

FIG. 8 is a rear plan view of the lighting control unit of FIG. 1.

FIG. 9 is a top plan view of the lighting control unit of FIG. 1.

FIG. 10 is the bottom plan view of the lighting control unit of FIG. 1.

FIG. 11 is a basic circuit diagram of a lighting control unit according to the present invention.

FIG. 12 is a basic circuit diagram of an alternate embodiment of the invention.

### DETAILED DESCRIPTION OF THE PREFERRED EMBODIMENT

With reference now to the drawings, the preferred embodiment of the lighting control unit is herein described. It should be noted that the articles “a”, “an”, and “the”, as used in this specification, include plural referents unless the content clearly dictates otherwise.

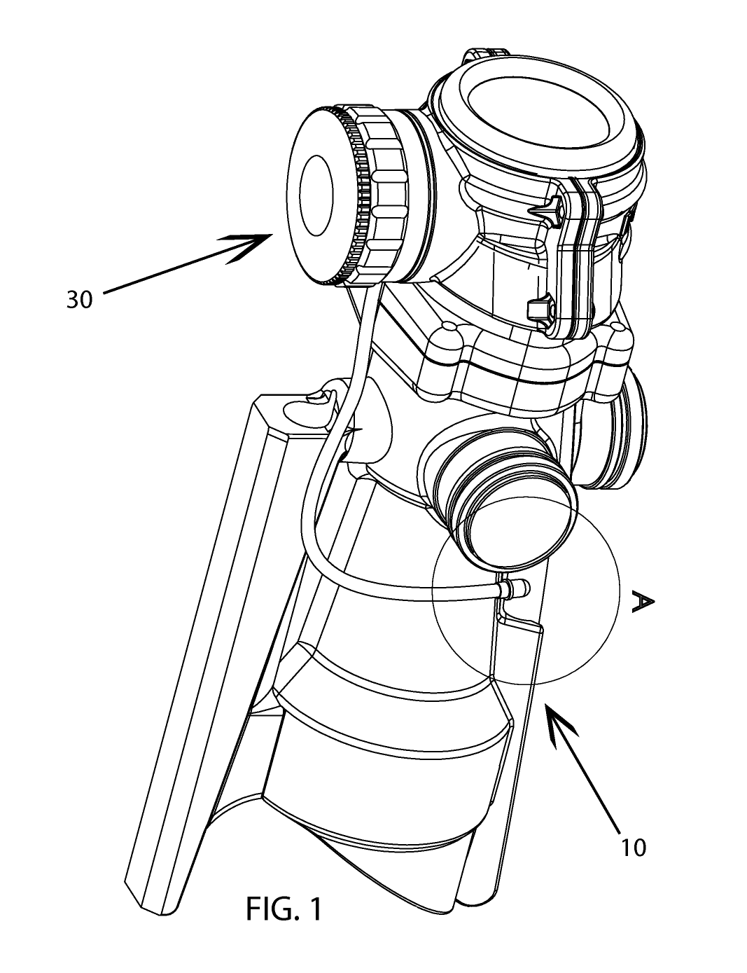

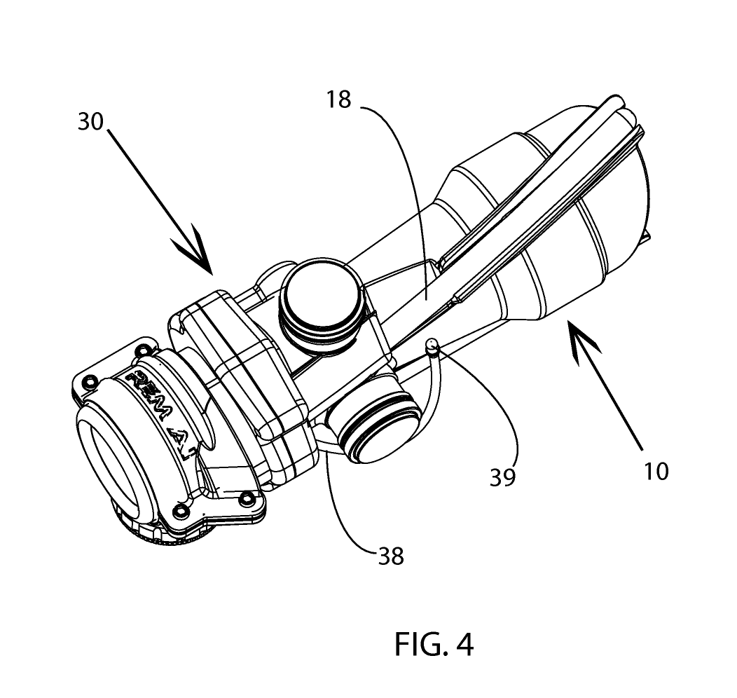

With reference to FIGS. 1-4, a lighting control unit 30 is configured to mount upon a scope 10. The scope is representative of any device that may utilize ambient light for some purpose, such as illuminating a reticule. In the illustrated scope, a light collecting wave-guide 18 resides along an upper surface of the scope body 12, extends toward the objective lens 14, and collects and channels ambient light in a manner to illuminate a reticule. This common strategy is known in the art and numerous constructions are utilized to accomplish this objective. Therefore, the illustrated scope should not be seen as limiting the invention, as the invention may be adapted to the different constructions.

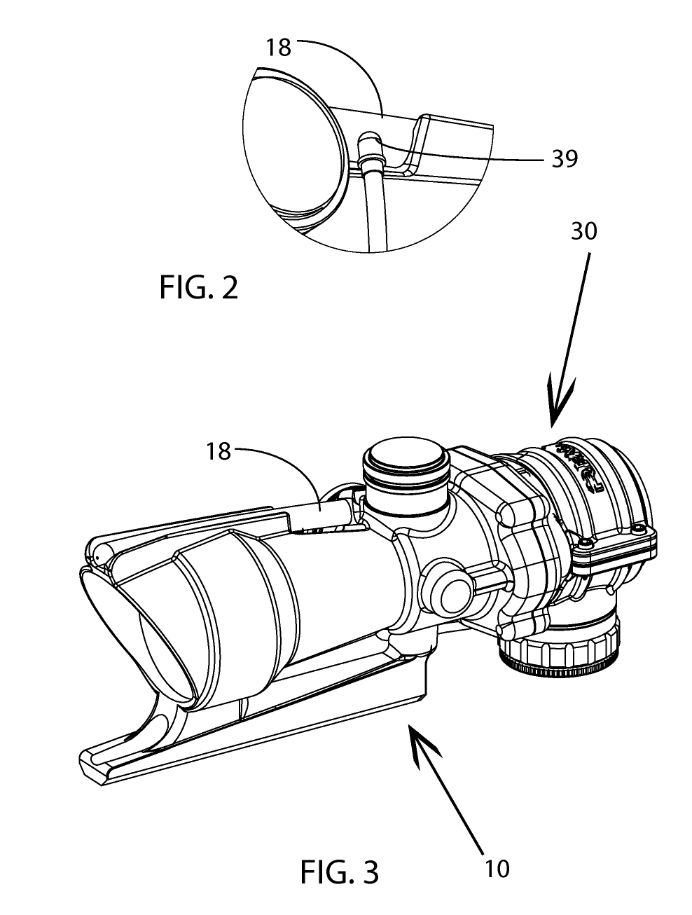

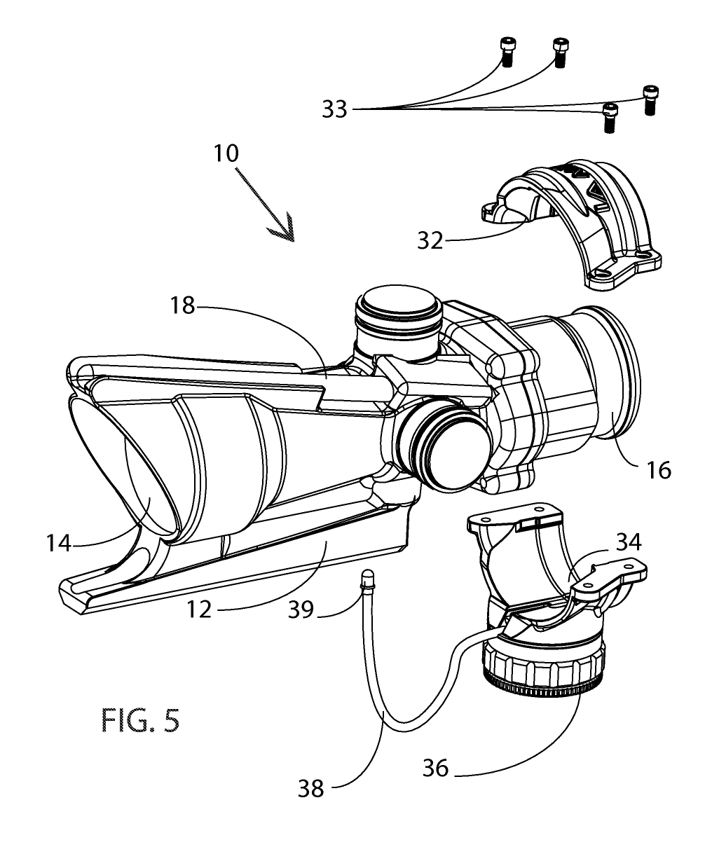

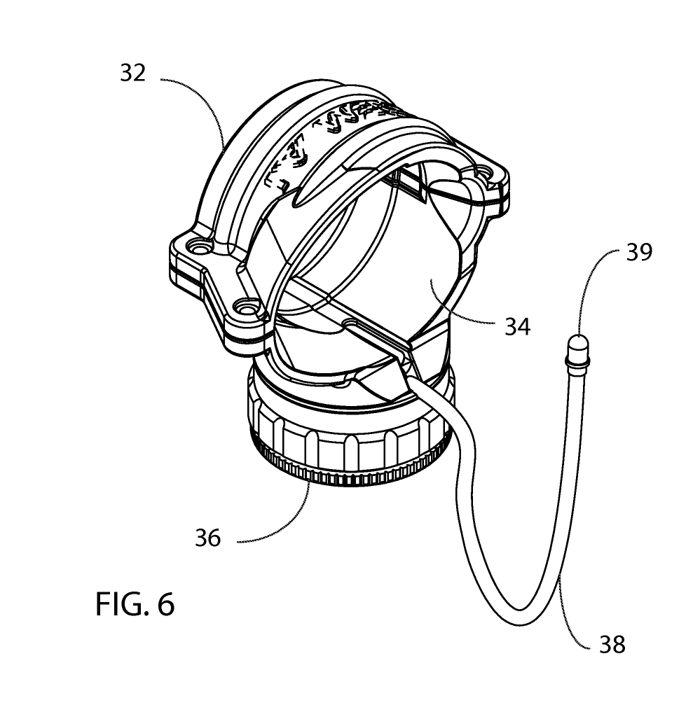

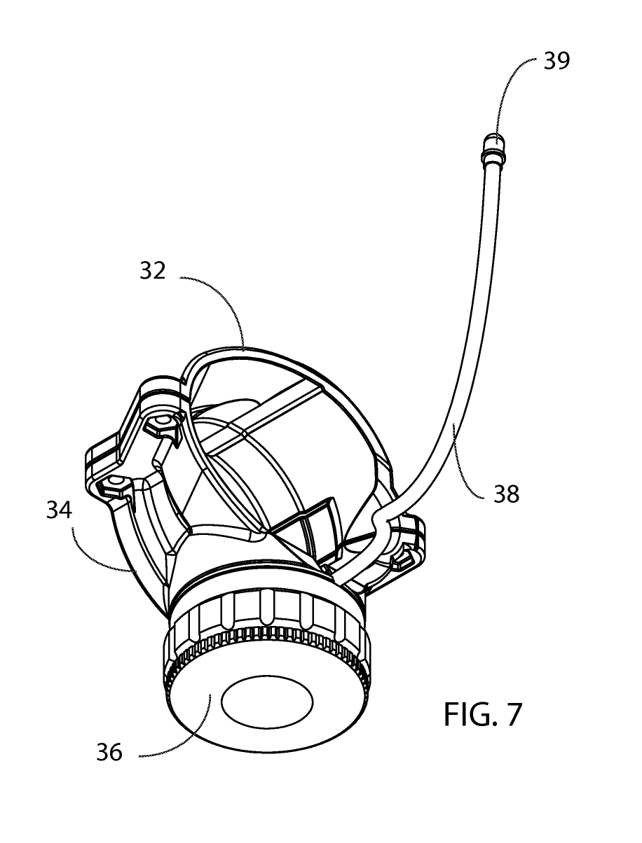

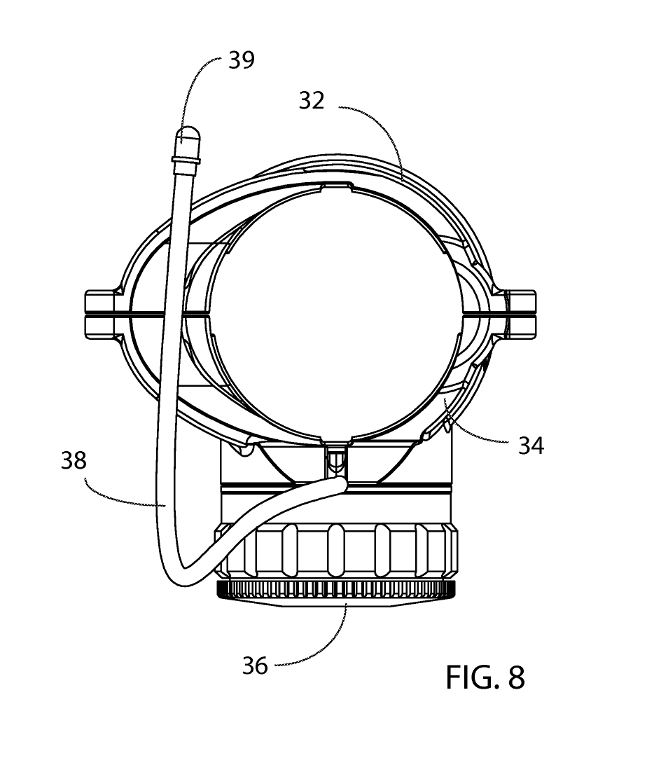

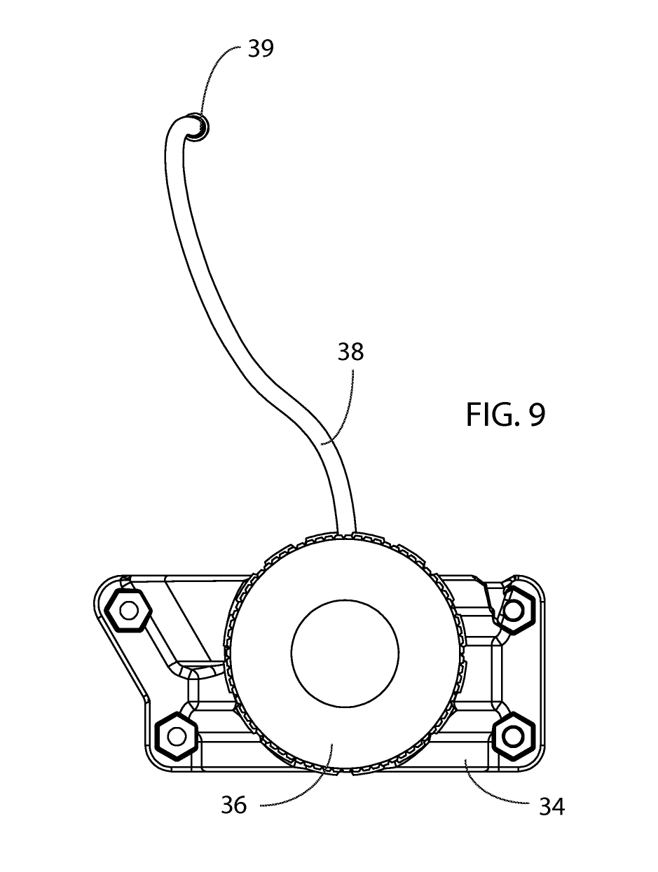

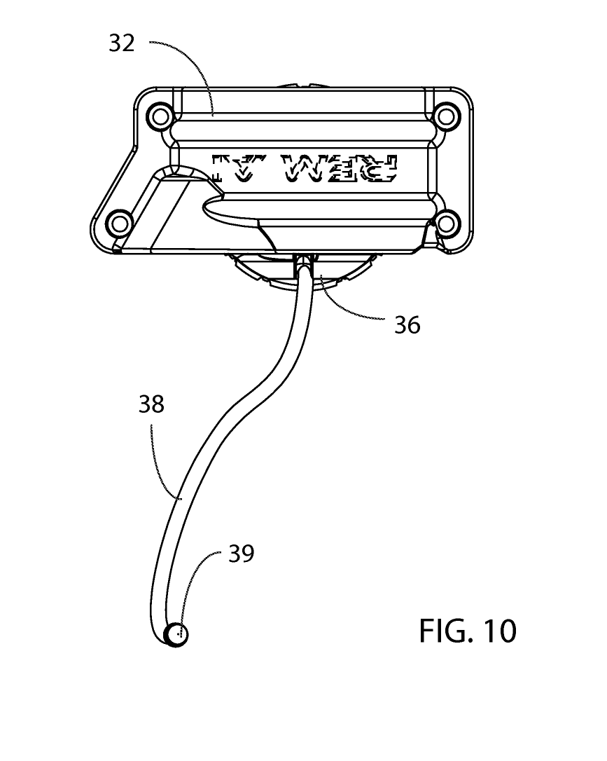

The illustrated lighting control unit 30 clamps on the scope body 12 near the eyepiece 16, as shown in FIG. 5. Upper 32 and lower 34 haves of the clamp are joined about the eyepiece 16 and secured by a plurality of bolts 33 or other similar structures. The control unit 30 may occupy the lower half of the clamp 34. It is to be understood that positioning of the control unit 30 is a matter of preference and it may be positioned on the upper clamp 32, or the clamp may be designed in a side to side fashion or in any way conceivable by the imagination. As can be seen in FIGS. 6-10, the control unit 30 features a dial controlled rheostat 36 and a fiber optic wave-guide 38 which is bent in a manner to position its terminal end 39 by the ambient light collecting wave-guide 18 of the scope 10 as shown in FIG. 2. The structure of the control unit is simple so as to minimize weight and volume and it is manufactured to position the dial control for the rheostat 36 in an ergonomic position for activation by a user. The wave-guide 38 may be pre-bent in position for a given device or may be flexible for positioning by the user.

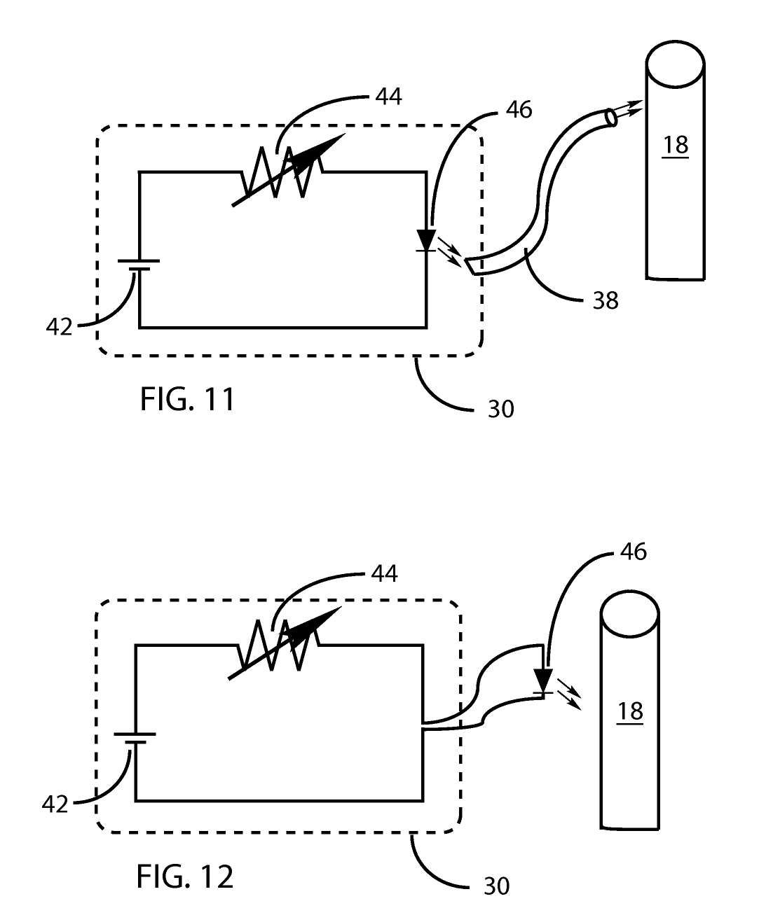

The circuitry of the control unit 30 is also a simple construction, as shown in FIG. 11. A small power source 42 is stowed within the lighting control unit 30 a rheostat or other variable resistor 44 is employed as a switch and intensity control. The circuit controls an LED 46. In the preferred embodiment, the wave-guide 38 then channels light from the LED 46 to the light collecting wave-guide 18. An alternate embodiment (FIG. 12) places the LED 46 outside of the control unit 30, proximate the light collecting wave-guide 18 and removes the lighting control unit's wave-guide 38. The LED 46 may be mounted upon a flexible structure that, like the original wave-guide 38, may bend to adapt to a desired device while also protecting the wiring inside. By keeping the circuitry simple, the space needed to be occupied by the control unit may be kept to a minimum. It is however readily understood that additional features may be added to the invention which would require additional circuitry components. Such additions are still to be understood to be within the purview of this invention.

Although the present invention has been described with reference to preferred embodiments, numerous modifications and variations can be made and still the result will come within the scope of the invention. As an example, the invention has been described in reference to a retrofitting structure, but may be made integral to the host device. No limitation with respect to the specific embodiments disclosed herein is intended or should be inferred.

What is claimed is:

1. A lighting control unit comprising:
a. a mounting bracket;
b. a control unit integral with the bracket, the control unit further comprising:
i. a light source mounted within the control unit;
ii. a power supply to provide power to the light source; and
iii. a lighting power control for the adjustment of power to the light source; and
c. a waveguide with one end proximate the light source;
wherein light emanating from the light source is collected by the wave-guide at the end proximate the light source and then directed through the waveguide to an opposite end.

2. The lighting control unit of claim 1, the mounting bracket being configured to attach the lighting control unit to a scope.

3. The lighting control unit of claim 1, the light source being an LED.

4. The lighting control unit of claim 1, the opposite end of the waveguide being proximate an end of a waveguide for directing ambient light into a device with an ambient light powered reticule.

5. The lighting control unit of claim 1, the lighting power control further comprising a controllable rheostat.

6. The lighting control unit of claim 1, the wave-guide being flexible so as to direct light to a wide range of locations along a host device.

7. A lighting control unit comprising:
a. a mounting bracket;
b. a control unit integral with the bracket, the control unit further comprising:
i. a power supply; and
ii. a lighting power control for adjustment of power; and
c. a light source external of a body of the control unit;
wherein the power supply provides and the lighting power control regulates power supplied to the light source.

8. The lighting control unit of claim 7, the mounting bracket being configured to attach the lighting control unit to a scope.

9. The lighting control unit of claim 7, the light source being an LED.

10. The lighting control unit of claim 9, the LED being proximate an end of a waveguide for directing ambient light into a device with an ambient light powered reticule.

11. The lighting control unit of claim 9, the LED being mounted on a flexible structure so as to direct light to a wide range of locations along a host device.

12. The lighting control unit of claim 7, the lighting power control further comprising a controllable rheostat.
